(19) United States
(12) Patent Application Publication
(10) Pub. No.: US 2026/0122475 A1
(43) Pub. Date: Apr. 30, 2026

(54) CLOUD SIM LOCATED AT OR NEAR INTERNATIONAL BORDERS ALLOCATION METHOD AND SYSTEM, AND DEVICE AND STORAGE MEDIUM THEREOF

(71) Applicant: Shanghai TUGE Data Technologies Co., Ltd., Shanghai (CN)

(72) Inventors: Shaocan WANG, Shanghai (CN); Kaihang WANG, Shanghai (CN); Hao ZHOU, Shanghai (CN)

(73) Assignee: Shanghai TUGE Data Technologies Co., Ltd., Shanghai (CN)

(21) Appl. No.: 19/373,702

(22) Filed: Oct. 29, 2025

Related U.S. Application Data
(63) Continuation of application No. PCT/CN2025/073496, filed on Jan. 21, 2025.

(30) Foreign Application Priority Data
Oct. 30, 2024 (CN) 202411523776.1

(51) Int. Cl. H04W 8/20; H04W 4/02; H04W 12/069

(52) U.S. Cl. CPC H04W 8/205; H04W 4/023; H04W 12/069

(57) ABSTRACT

The provided are a cloud SIM allocation method and system, and a device and a storage medium thereof. The method includes: step S1, acquiring a camped cell identity (ID) and a timing advance (TA) value of a terminal device; step S2, determining a roaming state of the terminal device based on the camped cell ID and the TA value, the roaming state comprising an international roaming state and a local roaming state; and step S3, allocating a cloud SIM based on the roaming state of the terminal device. The camped Cell ID and TA value of the terminal device are utilized to identify a cross-border border state thereof. This avoids using signals from cross-border operators, and shields signal interference from neighboring countries. The cloud SIM allocation process is optimized, the time required for frequency band scanning is reduced, and the stability of network communication and user experience are enhanced.

### CROSS-REFERENCE TO THE RELATED APPLICATIONS

This application is a continuation application of International Application No. PCT/CN2025/073496, filed on Jan. 21, 2025, which is based upon and claims priority to Chinese Patent Application No. 202411523776.1, filed on Oct. 30, 2024, the entire contents of which are incorporated herein by reference.

### TECHNICAL FIELD

The present disclosure relates to the technical field of communications, and in particular, relates to a cloud SIM allocation method and system, and a device and storage medium thereof.

### BACKGROUND

Conventional cloud communication technologies primarily rely on the quality of service (QoS) of a virtual subscriber identity module (SIM) to determine a target virtual SIM for use. This approach necessitates that the terminal device downloads at least two virtual SIM profiles, and thus network switching is insufficiently flexible. When a terminal device is in a state of high-speed motion, frequent changes in its serving cell information create a risk of “ping-pong handover” (i.e., rapid and repeated switching between two adjacent cells). Furthermore, during network selection on some dual-mode terminals, the access technologies of the two network systems supported by the terminal are treated as completely separate. The network selection method, which operates independently for each single access technology, requires a prioritized scheme to be pre-configured on the terminal side. This prevents the terminal from flexibly selecting an optimal cell for network registration.

### SUMMARY

To address the above defects, in a first aspect, embodiments of the present disclosure provide a cloud SIM allocation method. The method includes:
step S1: acquiring a camped cell identity (ID) and a timing advance (TA) value of a terminal device; wherein the TA value is a timing advance estimated by the terminal device to avoid a radio frequency (RF) transmission delay caused by an uplink transmission distance between the terminal device and a base station, and receiving the camped cell ID and the TA value reported by an embedded seed SIM of the terminal device;
step S2: determining a roaming state of the terminal device based on the camped cell ID and the TA value, the roaming state comprising an international roaming state and a local roaming state; wherein based on the camped cell ID and the TA value reported by a seed SIM, the server converts the TA value into a distance between the terminal device and the base station, compares the distance with a distance between a national border and the base station, and determines the roaming state of the terminal device in combination with big data information from a backend database; and
step S3: allocating a cloud SIM based on the roaming state of the terminal device;

wherein when the terminal device is in a first country and is in the local roaming state, the server continues to allocate a cloud SIM of the first country to the terminal device; and when the terminal device is in a second country and is in the international roaming state, the server re-searches for signals from an operator in the second country and allocates a cloud SIM of the second country to the terminal device.

In some embodiments, the camped cell ID includes a mobile country code (MCC), a mobile network code (MNC), a tracking area code (TAC), and a cell identity (CI); the database records information including a longitude and a latitude of the national border, a longitude and a latitude of a base station near the national border, and a cell ID within coverage of the base station; and step S2 includes the following sub-steps:
sub-step S2.1: calculating a straight-line distance between the national border and the base station to acquire a first distance; wherein the base station is determined based on the camped cell ID;
sub-step S2.2: converting the TA value of the terminal device into a straight-line distance from the terminal device to the base station to acquire a second distance; and
sub-step S2.3: comparing a value of the second distance with a value of the first distance to determine the roaming state of the terminal device.

In some embodiments, allocating the cloud SIM to the terminal device for registration includes the following sub-steps:
sub-step S3.1: selecting a SIM-supply country and an operator based on the roaming state of the terminal device determined in step S2;
sub-step S3.2: upon receiving a registration request from the seed SIM, sending an authentication request containing encrypted information to the seed SIM, receiving an authentication response generated by the seed SIM based on the encrypted information, and performing decryption and verification using a corresponding secret key stored in a cloud SIM pool of the server; wherein in a case where the verification is successful, network access authentication for the seed SIM is successful; and
sub-step S3.3: allocating the cloud SIM from the cloud SIM pool to the terminal device.

In some embodiments, the seed SIM is a virtual Ki card with a built-in calculation key.

In some embodiments, in step S3, the server directly searches for operator frequency bands of a current country; when the terminal device is in the local roaming state, the server directly excludes foreign operators and provides operator frequency band information of the first terminal to the terminal device for selection; and when the terminal device is the international roaming state, the server only acquires operator frequency band information of the second country and provides the operator frequency band information to the terminal device for selection.

In some embodiments, the server, in conjunction with the database and based on the camped cell ID, preferentially allocates the cloud SIM of an operator from the operator frequency bands of the current country based on o a degree of frequency coverage.

In some embodiments, a numerical range of the TA value and a distance represented by the TA value are determined based on a communication standard and an operational state.

In a second aspect, embodiments of the present disclosure provide a cloud SIM allocation system. The system includes:
a terminal device, including a terminal algorithm module, a terminal operating system, and a cloud SIM network access module; and
a server, including a cloud SIM network-side module, a cloud SIM pool, and a database;
wherein the terminal algorithm module is configured to calculate a first distance between a national border and a base station, and convert a TA value into a second distance from the terminal device to the base station; and the server is configured to compare the first distance with the second distance, and determines a roaming state of the terminal device in conjunction with big data information in the database.

In a third aspect, embodiments of the present disclosure provide a device. The device includes a memory, a processor, and a program that is stored in the memory and executable on the processor; wherein the computer program, when loaded and run the processor, causes the processor to perform the method according to the first aspect.

In a fourth aspect, embodiments of the present disclosure provide a computer-readable storage medium, storing one or more executable instructions or programs therein, wherein the one or more executable instructions or programs, when executed by a processor, cause the processor to perform the method according to the first aspect.

The present disclosure provides a cloud SIM allocation method and system, and a device and computer-readable storage medium therefor. The method identifies a roaming state of a terminal device based on a camped cell ID and a TA value. This avoids using signals from cross-border operators, and shields signal interference from neighboring countries, thereby enhancing the stability and reliability of cloud communications. The roaming state of a user may be determined even in the absence of GPS location information from the terminal device. This mitigates adverse impacts on user experience caused by factors such as network coverage limitations and prevents the degradation of network quality that occurs when terminal devices lacking GPS satellite positioning capabilities are unable to determine their location in a timely manner. A server, by acquiring operator network information, selects only networks of operators in the current country for registration. This reduces the time required for frequency band scanning and accelerates the registration speed. Furthermore, the solution prevents the “ping-pong handover” issue that arises from frequent changes in cell information when the terminal device is in a state of high-speed motion, thereby improving the flexibility and stability of network handover.

In summary, the disclosed solution utilizes the camped Cell ID and TA value of the terminal device to identify a cross-border border state thereof. This optimizes the cloud SIM allocation process, enhances the stability of network communication and user experience, while simultaneously preventing network quality issues attributable to cross-border roaming.

The inventive concept, specific structure and the technical effects of the present disclosure are further described hereinafter with reference to the accompanying drawings, for the purpose of better and sufficiently understanding the objective, features and technical effects of the present disclosure.

### BRIEF DESCRIPTION OF THE DRAWINGS

FIG. 1 is a schematic flowchart of a cloud SIM allocation method according to some embodiments of the present disclosure;

FIG. 2 is a specific schematic flowchart of the cloud SIM allocation method in FIG. 1;

FIG. 3 is a schematic diagram of determining a position of a terminal device based on a TA value and a camped cell ID; and

FIG. 4 is a schematic structural diagram of a cloud SIM allocation system according to some embodiments of the present disclosure.

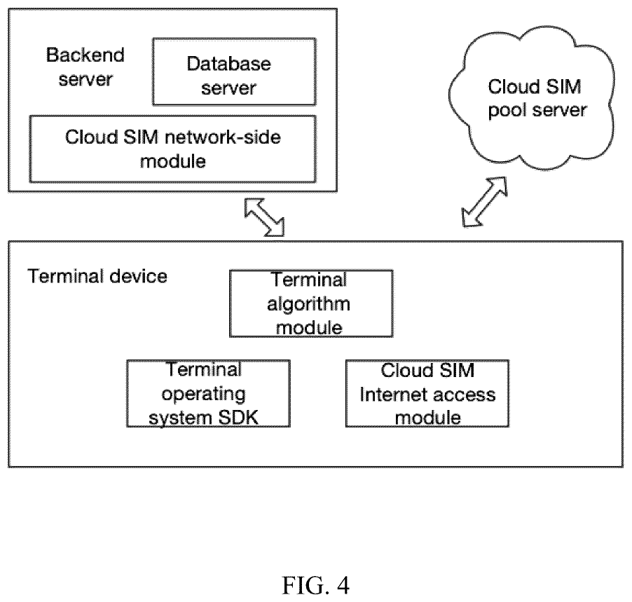

### DETAILED DESCRIPTION OF THE EMBODIMENTS

For a clear understanding of the technical means, inventive features, objectives, and technical effects of the present disclosure, the present disclosure is further described in detail with reference to the accompanying drawings. It should be noted, however, that the present disclosure is not limited to the embodiments described hereinafter.

Furthermore, it is to be understood that the structures, proportions, dimensions, and other details depicted in the drawings appended to the present disclosure are for illustrative purposes only, to aid a person skilled in the art in understanding the disclosure. They are not intended to limit the implementation scope of the present disclosure and therefore are not technically limiting in a substantive sense. Any modification of the structure, alteration of proportional relationships, or adjustment of dimensions, provided that it does not affect the efficacy and objectives achievable by the present application, shall fall within the scope of the technical solutions disclosed herein.

Furthermore, the terms “first,” “second,” “third,” “fourth,” and “fifth” are used for descriptive purposes only, to distinguish one entity or operation from another. These terms are not to be construed as indicating or implying any relative importance, a limitation on the number of technical features indicated, or any actual relationship or order between these entities or operations. For any single technical feature described or implied in the embodiments mentioned herein, or any single technical feature shown or implied in the respective drawings, the present disclosure still allows for any further combination or deletion between these technical features (or equivalents thereof) without any technical impediment. Therefore, it should be considered that these further embodiments according to the present disclosure are also within the scope of the disclosure herein.

The terms such as “comprising” and “including” indicate that, in addition to components directly and explicitly stated in the specification and claims, the technical solutions according to the present disclosure do not preclude the possibility of having other components that are not directly or explicitly stated.

The inventor(s) of the present disclosure has/have found that: for a device located at or near a national border, because the coverage area of base station signals may cross national borders, the device may receive signals from neighboring countries. Base station signals near the national border may overlap, and thus the device may simultaneously receive signals from two or more countries. This situation is common in cross-border regions. In a case where a device in a cross-border region registers onto an operator network of a neighboring country, the device may be in an international roaming state while still physically in the home country. This may not only affect the quality of network communication but also incur additional charges.

In summary, current communication for devices at or near international borders faces problems such as inflexible network handover, high requirements for the terminal device, a risk of ping-pong handover, inflexible network selection methods, and frequent cross-border signal interference. These problems severely affect the stability of network communication and user experience.

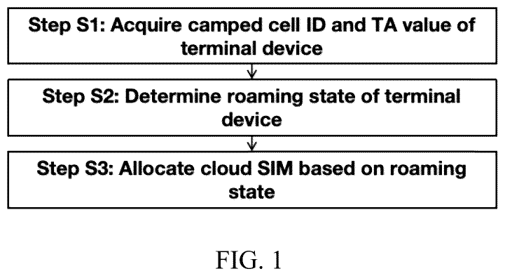

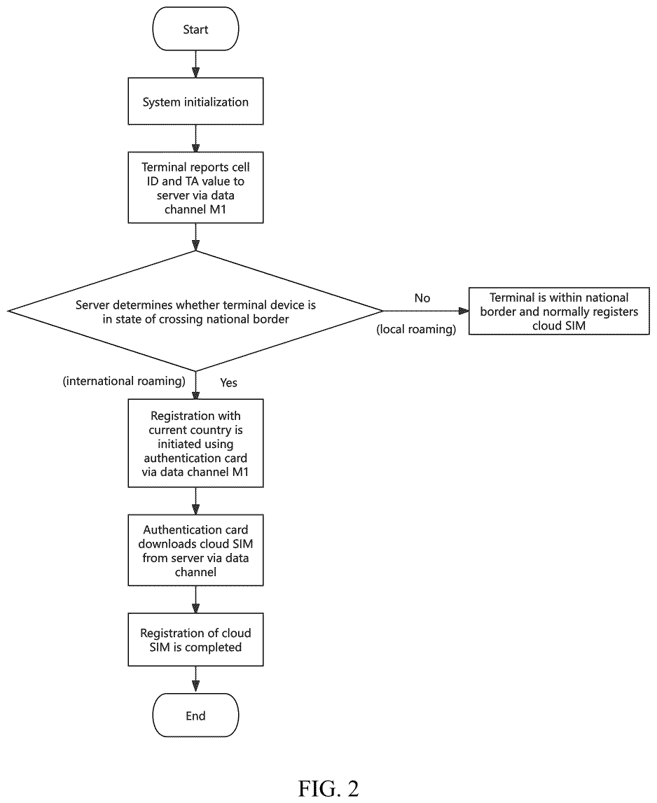

As illustrated in FIG. 1 and FIG. 2, the method may specifically include the following steps.
Step S1: A server acquires a camped cell ID and a TA value of a terminal device, wherein the camped cell ID refers to an ID of a cell where the terminal device is camped.

In step S1, upon power on of the terminal device, a seed SIM embedded within the terminal device may report the camped cell ID and the TA value to the server via a data channel. The server receives the camped cell ID and the TA value reported from the seed SIM.

Specifically, upon power on of the terminal device, the terminal device may register with a mobile network via the embedded seed SIM. During this process of registering with the network via the seed SIM, the terminal device acquires the camped cell ID of a currently accessed network. The camped cell ID includes an MCC, an MNC, a TAC, and a Cell ID. The MCC is used to identify a country, the MNC is used to identify an operator, the TAC is used to identify a tracking area of the cell, and the cell ID is used to identify a specific cell. A combination of these information codes forms a globally unique cell ID, which is used to identify a specific cell which the terminal device is currently connected to. Meanwhile, the terminal device measures a signal propagation delay between the terminal and the base station, and calculates the TA value based on the signal propagation delay. The TA value may indirectly reflect a distance between the terminal device and the base station. The terminal device reports the TA value to the server, and thereafter the server subsequently may use the data information to determine whether the terminal device is within the home country, thereby determining a roaming state. In this way, corresponding and appropriate cloud SIM allocation and registration strategies are adopted.

It should be noted herein that “M1” and “M2” in FIG. 2 represent two mutually independent data channels. In the embodiments, the data channel M1 is primarily configured to transmit and upload data information. Specifically, the seed SIM registers with the current country via the data channel M1, and reports the camped cell ID and the TA value of the device via the data channel M1, such that the server acquires only operator frequency band information of the current country for the terminal device to search within frequency bands of the current country. The terminal device downloads a cloud SIM from a cloud SIM pool of the server via the data channel M2.

It should be noted herein that the present disclosure primarily addresses the cloud SIM allocation issue for terminal devices near a national border, for scenarios where the terminal device, although having searched for international roaming signals outside the current country, is uncertain as to which signal is more suitable. Therefore, the server compares the camped cell ID and the TA value of the terminal device with big data information in a database, and determines the international roaming state of the terminal device using a distance between the base station and the national border as a reference. When the terminal device is within the coverage area of the base station within the national border, it is determined that the terminal device has not crossed the border; otherwise, it is determined that the terminal device has crossed the border.

The TA value is used for uplink transmission of a user equipment (UE), i.e., a terminal device. To ensure that uplink data packets from the UE are delivered to the base station within a desired time window, the terminal device estimates a radio frequency (RF) propagation delay caused by a distance thereof from the base station, and transmits the data packets in advance by a corresponding amount of time. The TA value is inherently used to ensure, during uplink transmission of the terminal device via an air interface, ensuring that uplink transmissions from all UEs are synchronously received by the base station. According to the present disclosure, the distance between the base station and the terminal device is calculated based on the TA value.

The distance between the terminal device and the base station may be deduced based on the TA value.

It should be noted that the TA value is determined by the base station based on measurement of the uplink signal received from the terminal device. The method of converting the TA value to a represented distance thereof to acquire the distance from the terminal device to the base station according to the present disclosure is applicable to, but not limited to, 2G/3G/4G/5G communication scenarios. Theoretically, TA measurement may be performed for any uplink signal from the terminal device. However, which signal is actually used for measurement depends on the implementation on the base station. However, an initial TA value, i.e., a TA value carried in Msg2 (random access response, RAR), is definitely measured via a RACH preamble. This is because the base station needs to issue a TA command in Msg2.

Specifically, in a long-term evolution (LTE) (4G wireless communication standards) system, calculation of the TA value is performed using two mechanisms (procedures) corresponding to a random access state and a connected mode state, and the corresponding TA value ranges also differ. The TA value represents a distance between the device terminal, i.e., UE, of the user and an antenna port of the base station. In a case where a step size represented by the TA value remains constant, the distance represented by the TA value=propagation speed (speed of light)×1 Ts/2 (for uplink and downlink paths). Thus, a distance represented by 1 Ts corresponds to (3×10⁸ m/s×1/(15000×2048) s)/2=4.89 m.

In the random access state, an LTE base station (eNodeB) measures an uplink physical random access channel (PRACH) preamble and carries 11 bits of information in a MAC payload of the RAR. The TA value ranges from 0 to 1282. Based on the TA value in the RAR, the UE adjusts the uplink transmission timing Nta=TA value×16 Ts, wherein the value is always positive. For example, when TA value=1, Nta=1×16 Ts. The distance represented by this TA value is 16×4.89 m=78.12 m (i.e., the TA value precision is approximately 78.12 meters). Concurrently, it can be calculated that during the initial access phase, the maximum access distance between the device terminal and the network base station=1282×78.12 m=100,156.24 m (approximately 100.156 km).

In the aforementioned LTE and NR (5G communication standard) communications, the precision of the TA value (i.e., the distance represented by one TA value) ranges from approximately 9.77 meters to 78.12 meters, which may be specifically determined according to the frequency and subcarrier spacing (SCS). Specifically, in a case where the subcarrier spacing in 5G is the same as that in LTE, i.e., 15 kHz, the distance represented by the TA value is also 78.12 meters. In a case where the subcarrier spacing is 30 kHz, the distance represented by the TA value is 39.06 meters. In a case where the subcarrier spacing is 60 kHz, the distance represented by the TA value is 19.53 meters. In a case where the subcarrier spacing is 120 kHz, the distance represented by the TA value is 9.77 meters. Optionally, in NR communication, the MAC payload during a random access process carries 12-bit TA information, and thus the range of the TA value at this time is between 0 and 3846.

In the connected mode state (service ongoing state), a periodic TA command is conveyed as a 6-bit information field within the MAC layer, and thus the TA value ranges from 0 to 63. The TA command Nta_new=Nta_old+(TA value−31)×16 Ts, and the TA value may be positive or negative. For example, when TA value=30, Nta_new=Nta_old+(30−31)×16 Ts. The distance represented by this is equal to −1×16×4.89 m=−78.12 m. According to the formula, a minimum distance represented by the TA value may be calculated as −31×16×4.89 m=−2420 m (approximately-2.42 km), and a maximum distance represented by the TA value is 32×16×4.89 m=2500 m (approximately 2.5 km).

However, in 2G (global system for mobile communications, GSM) communication, each step of the TA value represents an advance of one period (approximately 3.69 microseconds). In a case where radio waves travel at a speed of 300 meters per microsecond (300,000,000 meters per second), each step of the TA value represents an uplink transmission distance from the terminal device to the base station of 550 meters, that is, a round-trip transmission distance of 1100 meters. This implies that the TA value changes by one step for every 550-meter change in the range between the terminal device and the base station. The limit of 63×550 meters means that a maximum distance covered by signals that may be received by the terminal from the base station is 34,650 meters, approximately 35 kilometers. Meanwhile, this is also an upper limit of a cell coverage distance for the base station.
Step S2: The roaming state of the terminal device is determined. The roaming state may include an international roaming state and a local roaming state.

Upon receiving the camped cell ID and the TA value of the terminal device reported by the seed SIM of the terminal device, the server converts the TA value into the distance from the terminal device to the base station, compares the distance with the distance from the national border to the base station, and determines the roaming state of the terminal device in combination with the big data information from the backend database.

In the embodiments, the seed SIM is a virtual Ki authentication card that locally calculates a key. The cloud SIM allocation method according to the present disclosure does not rely on the seed SIM to switch card slots. The seed SIM according to the present disclosure is only used for reporting the camped cell ID and the TA value. Specifically, the seed SIM may acquire the ID of a cell where the terminal device is camped based on the longitude and latitude of the terminal device, and report the ID of the cell to the server.

The database records big data such as the longitudes and latitudes of the national border, the longitudes and latitudes of base stations near the national border, the coverage ranges of the base stations, and the cell IDs within that range. By comparing the reported TA value and the terminal device cell ID with the data, whether the terminal device is in the international roaming state is acknowledged.

Optionally, step S2 may specifically include the following sub-steps.
Sub-step S2.1: The server calculates a straight-line distance between the national border and the base station based on the longitudes and latitudes of the national border and the longitude and latitude of the base station in the database, and thus acquires a first distance. The server may determine, by comparing the camped cell ID with big data, the base station to which the camped cell belongs. Since the national border is an irregular line and equivalent to countless points with different longitudes and latitudes, in calculation of the straight-line distance from the national border to the base station, an intersection of the straight line connecting the terminal device and the base station with the national border is used as the longitude and latitude of the national border for the calculation step.

Since the base station and the national border are fixed and unchanged, the straight-line distance between the base station and the national border, i.e., the first distance, remains unchanged, and may be thus used as a benchmark for comparison.
Sub-step S2.2: The TA value of the terminal device is converted into a distance from the terminal device to the base station to acquire a second distance.

As previously described, the TA value in the embodiments ranges from 0 to 63, and each step represents an uplink transmission distance of 550 meters from the terminal device to the base station.

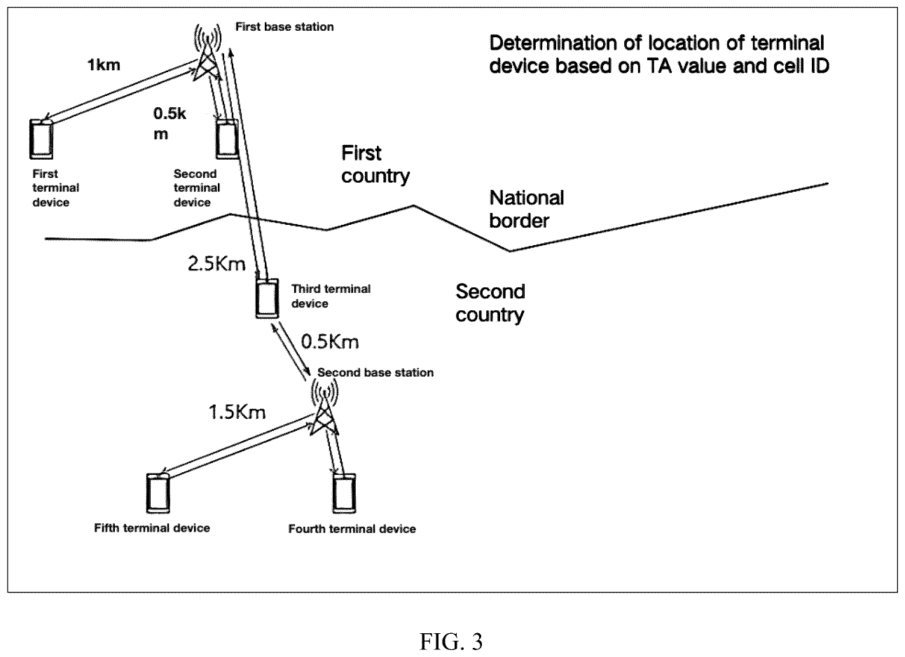

As illustrated in FIG. 3, the straight-line distance from a first terminal device to a first base station, i.e., the second distance for the first terminal device, is 1 km. The straight-line distance from a second terminal device to the first base station, i.e., the second distance for the second terminal device, is 0.5 km. Similarly, since a third terminal device simultaneously receives signal coverage from a first base station of a first country and a second base station of a second country, a straight-line distance from the third terminal device to the first base station is 2.5 km, and a straight-line distance from the third terminal device to the second base station is 0.5 km.
Sub-step S2.3: The second distance is compared with the first distance.

In a case where the second distance is less than the first distance, it is determined that the terminal device has not crossed the national border. For example, in a case where the second distances of the first terminal device and the second terminal device are both less than the first distance, it is determined that these two terminal devices are in the first country (home country), have not crossed the national border, and are in the local roaming state.

In a case where the second distance is greater than the first distance, it is determined that the terminal device has crossed the national border and is in the international roaming state. For example, in a case where the straight-line distance from the third terminal device to the first base station exceeds the distance from the first base station to the national border, it is determined that the third terminal device has crossed (moved beyond) the national border of the first country.
Step S3: A cloud SIM is allocated based on the roaming state.

The cloud SIM is a non-roaming SIM of a local operator. If the cloud SIM is registered with an operator providing international roaming at the national border, user experience may be affected by factors such as network coverage. The method prevents the terminal device from registering with the network of an international operator when near the national border, excludes interference from signals from a neighboring country, and enhances the stability of user experience. The cloud server may allocate cloud SIMs of the corresponding countries according to different roaming states, thereby enhancing the user experience.

Assuming the first country is the home country and the second country is a neighboring country, then when the terminal device is in the local roaming state in the first country, the server only allocates a local cloud SIM from an operator of the first country to the terminal device for registration. Assuming the first country is the home country and the second country is a neighboring country, then when the terminal device is in the international roaming state in the second country, the server researches signals from all international operators (relative to the first country) of the second country, and allocates a foreign cloud SIM of a foreign country of the second country (relative to the first country) to the terminal device for registration.

In some embodiments, the registration process wherein the server issues a cloud SIM to the terminal device may specifically include the following sub-steps.
Sub-step S3.1: A card-supply operator is selected based on the roaming state.

In the embodiments, the main basis for the server to select an operator is the national border, which conforms to legal principles and principles of actual network construction, prioritizing home country coverage. If the operator is not selected based on the country where the terminal device is located, it may lead to the signal of operator A1 from the first country overshooting its coverage into the second country. As illustrated in FIG. 3, when the third terminal device in FIG. 3 is in the second country, the seed SIM may first search for an A1 signal, mistakenly assume the third terminal device is in the first country, and thus allocate a cloud SIM of the first country to the user. However, in reality, the third terminal device of the user is in the second country and has received the signal of operator A1 from country A. The user's activity range is in the second country, which may inevitably lead to a poor signal quality when using the signal of operator A1 of the first country in the second country, which affects user experience. The A1 signal fails to provide continuous coverage in the second country, and indoor signal quality may be even worse. Merely due to an automatic search mechanism of the terminal device, the terminal device registers with the network of the first country once the A1 signal is found. The present disclosure effectively solves this problem.

Furthermore, the method is more efficient than traditional methods of determining cross-border location via GPS or Beidou satellite signal positioning, and the method also avoids the problem of network quality degradation caused by inappropriate allocation of roaming operators for some terminal devices that lack GPS satellite positioning and cannot promptly determine their location.
Sub-step S3.2: The seed SIM interacts with the cloud SIM pool of the server and passes authentication.

When the seed SIM is in a device that is powered on or requires network service, the seed SIM may a registration request to the server. This request typically includes unique identification information of the seed SIM (such as IMSI or device ID). Upon receiving the registration request, the server may send an authentication request to the seed SIM. This request contains an authentication challenge, usually a random number or specific encrypted information. The seed SIM uses a built-in key (such as Ki) to perform an encryption calculation, generates an authentication response, and sends the authentication response to the server. Upon receiving the authentication response, the server uses a corresponding key stored in the cloud SIM pool to perform decryption and verification. If the verification is successful, the legitimacy of the seed SIM is confirmed. In a case where the verification is successful, the seed SIM may perform data interaction with the cloud SIM pool of the server, which may include operations such as downloading cloud SIM information, updating configurations, and uploading state reports.
Sub-step S3.3: The server issues a cloud SIM from the cloud SIM pool, and the terminal device downloads the cloud SIM to complete registration.

The server may, based on the user's location (i.e., terminal device location), network conditions (i.e., operator signal coverage), and other policies, allocate one or more cloud SIMs from the cloud SIM pool to the seed SIM. The cloud SIM contains the authentication information required to access a specific network.

Through the above steps, the seed SIM may securely interact with the cloud SIM pool of the server, ensuring that only legitimate terminal devices is capable of accessing the network and acquiring corresponding services. This authentication mechanism helps prevent unauthorized access and network attacks, thereby protecting the security of user data and network resources.

Using the embodiment illustrated in FIG. 3 as an example, the scenario of the present disclosure is described in detail.

A base station is an infrastructure in a mobile communication network used for wireless communication with terminal devices, and may include a transmit device, a receive device, and an antenna system. The signal of a base station covers a specific geographical area. A cell is a geographical area covered by a base station. One base station may cover one or more cells. One macro base station may cover a plurality of cells, with each cell serving a different area, i.e., the coverage range of a base station is jointly formed by a plurality of cells. Each cell is responsible for covering a part of the geographical area of the base station. To improve spectral efficiency, adjacent cells may use the same frequency resources but avoid interference through different time or spatial separation.

As illustrated in FIG. 3, a first country and a second country are demarcated by a national border. It is assumed herein that the first country is the home country, and terminal devices located in the first country are all in the local roaming state. The second country is a neighboring foreign country, and terminal devices located in the second country are all in the international roaming state. It is assumed that operators in the first country include A1, A2, and A3. Operators own and operate these base stations. A plurality of operators may share the same physical base station, but each operator still uses independent frequency resources to provide communication services.

In the embodiments, a first terminal device and a second terminal device are in the first country (home country), and a third terminal device, a fourth terminal device, and a fifth terminal device are in the second country, i.e., a foreign country relative to the first country. Although the third terminal device is in the second country, the third terminal device may still receive signals from the first base station in the first country. In a case where the third terminal device is connected to and registers with the network via the signals of the first base station, network usage experience in the second country may be affected subsequently. Thee cloud SIM allocation method according to the present disclosure solves this problem. Subsequent to determining, based on the camped cell ID and TA value reported by the terminal device, that the third terminal device is in the second country, the server directly searches for operator frequency bands of the current country, and acquires only the operator frequency band information of the second country for the third terminal device to select instead of causing the third terminal device to be connected to the base station signal of the first country. When the terminal device (for example, the first terminal device and the second terminal device) is in the local roaming state, the server may directly exclude operator signals from the second country and provide operator frequency band information of the first country to the terminal device for selection.

In the embodiments, the server, in conjunction with the database, may preferentially allocate an operator's cloud SIM from the operator frequency bands of the current country based on the camped cell ID, according to the degree of frequency coverage, i.e., with reference to the signal coverage quality of operators when the communication standards are the same. For example, when the terminal device has a plurality of frequency bands available for use, the terminal device searches for a frequency band sequentially within an available frequency set {A1, A2, A3}. Where it is determined, based on known information, that there is no A1 or A2 frequency coverage, the terminal device directly skips to the A3 frequency. This method further saves frequency band search time and speeds up the registration process.

Specifically, in some embodiments, operators may use different frequency bands to distinguish between a coverage layer and a capacity layer to optimize network performance and user experience. For example, low-frequency bands such as 900 MHz are used to build a coverage layer, because signals in low-frequency bands travel farther and have stronger penetration capabilities, and thus provide a wider coverage range. These frequency bands are mainly used to ensure that users are capable of accessing the network, especially in remote areas or indoor environments. High-frequency bands such as 1800 MHz or higher are used to build a capacity layer, because these frequency bands have wider bandwidth, and may provide higher data transmission rates and a greater network capacity. When data traffic demands of a user are high or a higher network speed is required, the network may switch the user to these high-frequency band cells.

Within the same country, when a user moves or network conditions change, the network may perform cell handover between the coverage layer and the capacity layer based on user demands and signal quality to maintain optimal network connection and service quality. These handover operations belong to network management within the current country and may not cause the user to be connected to a foreign network.

In summary, operators distinguish between a coverage layer and a capacity layer by using different frequency bands, thereby ensuring that users are capable of accessing the network and acquiring a sufficient network capacity and speed where necessary. This strategy helps optimize the use of network resources and enhance user experience.

To achieve the above-mentioned objectives, the present disclosure further provides a cloud SIM allocation system for cross-border scenarios, which may specifically include a terminal device and a server.

In the embodiments, the terminal device may include, but is not limited to, a MiFi device, a mobile phone, a computer, or a tablet. The terminal device is inbuilt with a terminal operating system SDK, a terminal algorithm module, and a cloud SIM Internet access module. Upon power on, the terminal device processes and calculates the camped cell ID and the TA value via the terminal algorithm module. A seed SIM embedded in the cloud SIM Internet access module reports the camped cell ID and the TA value to the server via a data channel. The server may include a cloud SIM network-side module, a cloud SIM pool, and a database. The server compares the camped cell ID and the TA value with big data in the database to determine whether the roaming status of the terminal device is in the home country or cross-border. Specifically, the terminal algorithm module calculates a first distance between a national border and a base station, and converts a TA value into a second distance from the terminal device to the base station; and the server compares the first distance with the second distance, and determines a roaming state of the terminal device in conjunction with big data information in the database. The cloud SIM network-side module communicates with and authenticates the cloud SIM Internet access module of the terminal device. Upon completion of the authentication, the server issues a cloud SIM from the cloud SIM pool to the terminal device, and the cloud SIM Internet access module of the terminal device downloads the cloud SIM. Throughout the entire process, the terminal operating system SDK may implement interaction operations for user network registration.

Some embodiments of the present disclosure further provide a device. The device includes a memory, a processor, and a program that is stored in the memory and executable on the processor; wherein the computer program, when loaded and run the processor, causes the processor to perform the steps of the method according to any of the above embodiments.

The processor and the memory may be provided separately, or they may be integrated together, for example, integrated onto a system-on-chip (SoC) of the terminal device. It should be understood that the processor according to the embodiments of the present disclosure may be an integrated circuit chip having signal processing capabilities. During the implementation, various steps in the above method embodiments may be performed by means of an integrated logic circuit in the processor or by means of instructions. The processor may be a general processor, a digital signal processor (DSP), an application-specific integrated circuit (ASIC), a field-programmable gate array (FPGA) or another programmable logic device, a discrete gate or transistor logic device, or a discrete hardware component, or the like. The processor 320 is capable of implementing or performing the methods, steps and logic block diagrams in the embodiments of the present disclosure. The general-purpose processor may be a microprocessor or any customary processor or the like. The steps in the method according to the embodiments of the present disclosure may be directly reflected as being practiced by a decoding processor, or practiced by a software module plus hardware in the decoding processor. The software module may be located in a random memory, a flash memory, a read-only memory, a programmable read-only memory, an electrically erasable programmable memory, a register or the like storage medium commonly known in the art. The storage medium is within the memory. The processor reads the information stored in the memory and performs the steps of the above method in combination with the hardware thereof.

Some embodiments of the present disclosure further provide a computer-readable storage medium, storing one or more executable instructions or programs therein, wherein the one or more executable instructions or programs, when executed by a processor, cause the processor to perform the method as described above.

The computer-readable storage medium may be, for example, a memory. The memory may be a volatile memory or a non-volatile memory, or the memory may include a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random-access memory (RAM), which serves as an external high-speed cache. Through example but not limitative description, many forms of RAMs may be used, for example, a static random-access memory (SRAM), a dynamic random-access memory (DRAM), a synchronous dynamic random-access memory (SDRAM), a double data rate synchronous dynamic random-access memory (DDR SDRAM), an enhanced synchronous dynamic random-access memory (ESDRAM), a synchlink dynamic random-access memory (SLDRAM), and a direct rambus dynamic random-access memory (DR RAM).

Where the integrated units according to the embodiments are implemented in a form of a software functional unit and sold or used as an independent product, the units may be stored in the computer-readable storage medium. Based on such an understanding, the technical solutions of the present disclosure essentially, or the part contributing to the related art, or all or a part of the technical solutions may be implemented in a form of a software product. The software product is stored in a storage medium and includes several instructions to cause one or more devices (which may be personal terminals, servers, network devices, or the like) to perform all or some of steps of the methods described in the embodiments of the present disclosure.

Detailed above are merely exemplary embodiments for the purpose of illustrating the present disclosure. It should be noted that persons of ordinary skill in the art would derive various modifications or variations based on the inventive concept of the present disclosure without paying any creative effort. Therefore, all possible technical solutions reached by a person skilled in the art by means of logical analysis, reasoning or limited experiments or trials based on the inventive concept of the present disclosure and the related art shall fall within the protection scope defined by the appended claims.

1. A cloud SIM located at or near international borders allocation method, performed by a server, comprising:
step S1: acquiring a camped cell identity (ID) and a timing advance (TA) value of a terminal device; wherein the TA value is a timing advance estimated by the terminal device to avoid a radio frequency (RF) prorogation delay caused by an uplink transmission distance between the terminal device and a base station, and receiving the camped cell ID and the TA value reported by an embedded seed card of the terminal device;
step S2: determining a roaming state of the terminal device based on the camped cell ID and the TA value, the roaming state comprising an international roaming state and a local roaming state; wherein based on the camped cell ID and the TA value reported by a seed SIM, the server converts the TA value into a distance between the terminal device and the base station, compares the distance with a distance between a national border and the base station, and determines the roaming state of the terminal device in combination with big data information from a backend database; and
step S3: allocating a cloud SIM based on the roaming state of the terminal device; wherein when the terminal device is in a first country and is in the local roaming state, the server continues to allocate a cloud SIM of the first country to the terminal device; and when the terminal device is in a second country and is in the international roaming state, the server re-searches for signals from an operator in the second country and allocates a cloud SIM of the second country to the terminal device.

2. The cloud SIM located at or near international borders allocation method according to claim 1, wherein the camped cell ID comprises a mobile country code (MCC), a mobile network code (MNC), a tracking area code (TAC), and a cell identity (CI); the backend database records information comprising a longitude and a latitude of the national border, a longitude and a latitude of a base station near the national border, and a cell ID within coverage of the base station; and step S2 comprises the following sub-steps:
sub-step S2.1: calculating a straight-line distance between the national border and the base station to acquire a first distance; wherein the base station is determined based on the camped cell ID;
sub-step S2.2: converting the TA value of the terminal device into a straight-line distance from the terminal device to the base station to acquire a second distance; and
sub-step S2.3: comparing a value of the second distance with a value of the first distance to determine the roaming state of the terminal device.

3. The cloud SIM located at or near international borders allocation method according to claim 1, wherein allocating the cloud SIM to the terminal device for registration comprises the following sub-steps:
sub-step S3.1: selecting a SIM-supply country and an operator based on the roaming state of the terminal device determined in step S2;
sub-step S3.2: upon receiving a registration request from the seed SIM, sending an authentication request containing encrypted information to the seed SIM, receiving an authentication response generated by the seed SIM based on the encrypted information, and performing decryption and verification using a corresponding secret key stored in a cloud SIM pool of the server; wherein in a case where the verification is successful, network access authentication for the seed SIM is successful; and
sub-step S3.3: allocating the cloud SIM from the cloud SIM pool to the terminal device.

4. The cloud SIM located at or near international borders allocation method according to claim 3, wherein the seed SIM is a virtual Ki card with a built-in calculation key.

5. The cloud SIM located at or near international borders allocation method according to claim 3, wherein in step S3, the server directly searches for operator frequency bands of a current country; when the terminal device is in the local roaming state, the server directly excludes foreign operators and provides operator frequency band information of a first terminal to the terminal device for selection; and when the terminal device is the international roaming state, the server only acquires operator frequency band information of the second country and provides the operator frequency band information to the terminal device for selection.

6. The cloud SIM located at or near international borders allocation method according to claim 5, wherein the server, in conjunction with the backend database and based on the camped cell ID, preferentially allocates the cloud SIM of an operator from the operator frequency bands of the current country based on o a degree of frequency coverage.

7. The cloud SIM located at or near international borders allocation method according to claim 1, wherein a numerical range of the TA value and a distance represented by the TA value are determined based on a communication standard and an operational state.

8. A cloud SIM allocation system, comprising:
a terminal device, comprising a terminal algorithm module, a terminal operating system, and a cloud SIM network access module; and
a server, comprising a cloud SIM network-side module, a cloud SIM pool, and a database;
wherein the terminal algorithm module is configured to calculate a first distance between a national border and a base station, and convert a TA value into a second distance from the terminal device to the base station; and the server is configured to compare the first distance with the second distance, and determine a roaming state of the terminal device in conjunction with big data information in the database.

9. A device, comprising: a memory, a processor, and a program that is stored in the memory and executable on the processor; wherein the program, when being executed by the processor, causes the processor to perform the cloud SIM located at or near international borders allocation method as defined in claim 1.

10. A computer-readable storage medium, storing one or more executable instructions or programs therein, wherein the one or more executable instructions or programs, when executed by a processor, cause the processor to perform the cloud SIM located at or near international borders allocation method as defined in claim 1.

11. The device according to claim 9, wherein in the cloud SIM located at or near international borders allocation method, the camped cell ID comprises a mobile country code (MCC), a mobile network code (MNC), a tracking area code (TAC), and a cell identity (CI); the backend database records information comprising a longitude and a latitude of the national border, a longitude and a latitude of a base station near the national border, and a cell ID within coverage of the base station; and step S2 comprises the following sub-steps:
sub-step S2.1: calculating a straight-line distance between the national border and the base station to acquire a first distance; wherein the base station is determined based on the camped cell ID;
sub-step S2.2: converting the TA value of the terminal device into a straight-line distance from the terminal device to the base station to acquire a second distance; and
sub-step S2.3: comparing a value of the second distance with a value of the first distance to determine the roaming state of the terminal device.

12. The device according to claim 9, wherein in the cloud SIM located at or near international borders allocation method, allocating the cloud SIM to the terminal device for registration comprises the following sub-steps:
sub-step S3.1: selecting a SIM-supply country and an operator based on the roaming state of the terminal device determined in step S2;
sub-step S3.2: upon receiving a registration request from the seed SIM, sending an authentication request containing encrypted information to the seed SIM, receiving an authentication response generated by the seed SIM based on the encrypted information, and performing decryption and verification using a corresponding secret key stored in a cloud SIM pool of the server; wherein in a case where the verification is successful, network access authentication for the seed SIM is successful; and
sub-step S3.3: allocating the cloud SIM from the cloud SIM pool to the terminal device.

13. The device according to claim 12, wherein in the cloud SIM located at or near international borders allocation method, the seed SIM is a virtual Ki card with a built-in calculation key.

14. The device according to claim 12, wherein in step S3 of the cloud SIM located at or near international borders allocation method, the server directly searches for operator frequency bands of a current country; when the terminal device is in the local roaming state, the server directly excludes foreign operators and provides operator frequency band information of a first terminal to the terminal device for selection; and when the terminal device is the international roaming state, the server only acquires operator frequency band information of the second country and provides the operator frequency band information to the terminal device for selection.

15. The device according to claim 14, wherein in the cloud SIM located at or near international borders allocation method, the server, in conjunction with the backend database and based on the camped cell ID, preferentially allocates the cloud SIM of an operator from the operator frequency bands of the current country based on o a degree of frequency coverage.

16. The device according to claim 9, wherein in the cloud SIM located at or near international borders allocation method, a numerical range of the TA value and a distance represented by the TA value are determined based on a communication standard and an operational state.

17. The computer-readable storage medium according to claim 10, wherein in the cloud SIM located at or near international borders allocation method, the camped cell ID comprises a mobile country code (MCC), a mobile network code (MNC), a tracking area code (TAC), and a cell identity (CI); the backend database records information comprising a longitude and a latitude of the national border, a longitude and a latitude of a base station near the national border, and a cell ID within coverage of the base station; and step S2 comprises the following sub-steps:
sub-step S2.1: calculating a straight-line distance between the national border and the base station to acquire a first distance; wherein the base station is determined based on the camped cell ID;
sub-step S2.2: converting the TA value of the terminal device into a straight-line distance from the terminal device to the base station to acquire a second distance; and
sub-step S2.3: comparing a value of the second distance with a value of the first distance to determine the roaming state of the terminal device.

18. The computer-readable storage medium according to claim 10, wherein in the cloud SIM located at or near international borders allocation method, allocating the cloud SIM to the terminal device for registration comprises the following sub-steps:
sub-step S3.1: selecting a SIM-supply country and an operator based on the roaming state of the terminal device determined in step S2;
sub-step S3.2: upon receiving a registration request from the seed SIM, sending an authentication request containing encrypted information to the seed SIM, receiving an authentication response generated by the seed SIM based on the encrypted information, and performing decryption and verification using a corresponding secret key stored in a cloud SIM pool of the server; wherein in a case where the verification is successful, network access authentication for the seed SIM is successful; and
sub-step S3.3: allocating the cloud SIM from the cloud SIM pool to the terminal device.

19. The computer-readable storage medium according to claim 18, wherein in the cloud SIM located at or near international borders allocation method, the seed SIM is a virtual Ki card with a built-in calculation key.

20. The computer-readable storage medium according to claim 18, wherein in step S3 of the cloud SIM located at or near international borders allocation method, the server directly searches for operator frequency bands of a current country; when the terminal device is in the local roaming state, the server directly excludes foreign operators and provides operator frequency band information of a first terminal to the terminal device for selection; and when the terminal device is the international roaming state, the server only acquires operator frequency band information of the second country and provides the operator frequency band information to the terminal device for selection.
